(19) United States
(12) Patent Application Publication
(10) Pub. No.: US 2008/0065415 A1
(43) Pub. Date: Mar. 13, 2008

(54) Medical Practice Benchmarking

(75) Inventors: Michael Swain, Newton, MA (US); Todd Park, Canton, MA (US); Joseph Hendrickson, Belmont, MA (US)

Correspondence Address: PROSKAUER ROSE LLP, ONE INTERNATIONAL PLACE, BOSTON, MA, 02110, US

(73) Assignee: athenahealth, Inc., Watertown, MA (US)

(21) Appl. No.: 11/851,811

(22) Filed: Sep. 7, 2007

Related U.S. Application Data
(60) Provisional application No. 60/843,439, filed on Sep. 8, 2006.

(51) Int. Cl. G06Q 50/00; G06Q 10/00

(52) U.S. Cl. 705/2

(57) ABSTRACT

Medical practice information (e.g., insurance claim information) is received from a plurality of medical practices (e.g., 80% of the medical practices in Massachusetts). The medical practice information is combined together so that inter-practice statistics can be determined based on the aggregated practice information. The aggregated practice information is analyzed to remove all individual medical practice identifying information (e.g., the Winston Cardiologist Group address which associated with its patients). The inter-practice statistics includes, for example, payment time for a particular procedure for a particular medical specialty in a geographic region (e.g., cardiologists in Massachusetts urban areas receive insurance payments for an angioplasty in 14.5 days) and/or any other type of statistic associated with a medical practice (e.g., insurance claim hold time). The inter-practice statistics can be utilized to allow a medical practice to improve its insurance claim submissions based on successful submissions of other medical practices (e.g., emulating the submissions of successful medical practices).

### CROSS REFERENCE TO RELATED APPLICATIONS

This application claims the benefit of U.S. Provisional Patent Application No. 60/843,439, entitled “Medical Practice Benchmarking,” filed on Sep. 8, 2006, the disclosure of which is hereby incorporated by reference.

### FIELD OF THE INVENTION

The present invention relates to a method, system, and computer program product for medical practice benchmarking.

### BACKGROUND

Before the advent of networked systems and computers, medical patient workflow and billing was essentially a manual process. Doctors, nurses, receptionists, and the like used paper-based records to keep track of what procedures a patient had undergone, what the patient's insurance would and would not cover, and how claims for procedures were to be settled. As computers became more prevalent and widely utilized, many medical practitioners used computers for electronic record keeping and billing statement generation. To fill this niche, many companies began providing software to assist medical practitioners with managing their medical practice. The software and systems provided, however, typically solved only a particular problem (e.g., one company's software focused on billing automation, while another company's software focused on patient management).

### SUMMARY OF THE INVENTION

One approach to medical practice benchmarking is a computerized method. The computerized method includes receiving a plurality of practice information associated with a plurality of medical practices. The practice information includes insurance claim information and other information. The practice information is aggregated to form aggregated practice information. One or more inter-practice medical statistics are determined using the aggregated practice information. The statistics being associated with the insurance claim information and the statistics include at least one of a mean, a median, variance, deviation, quintile, average, sample size, or mode.

Another approach to medical practice benchmarking is a computer program product. The computer program product is tangibly embodied in an information carrier. The computer program product includes instructions being operable to cause a data processing apparatus to receive a plurality of practice information associated with a plurality of medical practices. The practice information includes insurance claim information and other information. The practice information is aggregated to form aggregated practice information. One or more inter-practice medical statistics are determined using the aggregated practice information. The statistics being associated with the insurance claim information and the statistics include at least one of a mean, a median, variance, deviation, quintile, average, sample size, or mode.

Another approach to medical practice benchmarking is a system. The system includes a medical practice module and an aggregate practice module. The medical practice module is configured to receive a plurality of practice information, which includes insurance claim information and other information, associated with a plurality of medical practices. The aggregate practice module is configured to aggregate the practice information to form aggregated practice information and determine one or more inter-practice medical statistics using the aggregated practice information. The statistics being associated with the insurance claim information and the statistics include at least one of a mean, a median, variance, deviation, quintile, average, sample size, or mode.

Another approach to medical practice benchmarking is a system. The system includes a means for receiving a plurality of practice information, which includes insurance claim information and other information, associated with a plurality of medical practices. The system further includes a means for aggregating the practice information to form aggregated practice information and determining one or more inter-practice medical statistics using the aggregated practice information. The statistics being associated with the insurance claim information and the statistics include at least one of a mean, a median, variance, deviation, quintile, average, sample size, or mode.

In other examples, any of the approaches above can include one or more of the following features. Practice identifiable information is removed from the aggregated practice information. The identifiable information includes doctor information, practice location information, practice information, and/or practice group information.

In some examples, the plurality of medical practices include a medical practice group. The medical practice group being grouped based on number of patients, number of doctors, medical specialty, and/or location.

In other examples, the one or more inter-practice medical statistics includes a lag time statistic, a payment statistic, a collection statistic, a denial statistic, and/or an insurance claim statistic. The one or more inter-practice medical statistics includes a statistical comparison between the aggregated practice information and the practice information associated with a first medical practice.

In some examples, the one or more inter-practice medical statistics are being utilized to improve at least one of insurance claim accuracy, insurance claim rejection rate, lag time, payment time, or an insurance claim submission. One or more insurance claims of a first medical practice are modified based on the one or more inter-practice medical statistics and the practice information associated with a first medical practice. The modification of the one or more insurance claim is utilized to improve a ranking of the first medical practice.

In other examples, the aggregated practice information is stored in an aggregated practice database. The one or more inter-practice medical statistics are transmitted to the plurality of medical practices. The one or more inter-practice medical statistics is determined in real-time. The one or more inter-practice medical statistics is determined on a periodic basis. The periodic basis is minutely, hourly, daily, weekly, monthly, quarterly, and/or yearly.

In some examples, a workflow processing module is configured to modify one or more insurance claims of a first medical practice based on the one or more inter-practice medical statistics and the practice information associated with the first medical practice.

In other examples, an aggregate practice information database is configured to store the aggregated practice information. The aggregate practice module is further configured to remove practice identifiable information from the aggregated practice information. The aggregate practice module is further configured to transmit the one or more inter-practice medical statistics to the plurality of medical practices.

An advantage to the medical practice benchmarking is that medical practices can efficiently and quickly determine if their individual insurance claim submission payment and/or acceptance statistics are within the normal ranges for their geographic, practice type, and/or group type. Another advantage is that the individual insurance claim rankings for a medical practice can be automatically and/or manually improved through a comparison of the insurance claim submissions of other medical practices.

Other aspects and advantages of the present invention will become apparent from the following detailed description, taken in conjunction with the accompanying drawings, illustrating the principles of the invention by way of example only.

### BRIEF DESCRIPTION OF THE DRAWINGS

The foregoing and other objects, features, and advantages of the present invention, as well as the invention itself, will be more fully understood from the following description of various embodiments, when read together with the accompanying drawings, in which:

FIG. 1 depicts a block diagram of an exemplary medical practice management system that includes medical practice modules, a medical practice management server, and an aggregate practice module;

FIG. 2 depicts a block diagram of an exemplary medical practice management system that includes a medical practice module and a plurality of medical practice databases;

FIG. 3 depicts a block diagram of an exemplary medical practice management system that includes a medical practice network, a medical practice management server, and a payor network;

FIG. 4A is a diagram depicting exemplary medical practice information;

FIG. 4B is a diagram depicting exemplary medical practice information;

FIG. 5 depicts a block diagram of exemplary medical practices databases communicating with a shared database;

FIG. 6 is a diagram depicting exemplary medical practice statistics;

FIG. 7 depicts a screenshot presented in a web browser of exemplary inter-practice statistics;

FIG. 8 depicts an exemplary flowchart of inter-practice statistics; and

FIG. 9 depicts an exemplary flowchart of insurance claim statistics.

### DETAILED DESCRIPTION

Automating medical practice workflow and billing presents difficulties in many aspects including the installation of a system, the processing the eligibility or other statuses of patients, the interacting with the workflow, other health care providers, and within the constraints of payor requirements, and measuring the success of a practice once it has been established. Additionally, it is often difficult, if not impossible, to gauge a medical practice's relative performance in various areas of the practice.

Periodically, it is useful for a medical practice to determine how well it is performing fiscally and compared to its peers in terms of patient service. Often this information is strictly confidential and is not shared among medical practices. For example, a medical practice may take a week to process a given claim. Is a week “normal” for a practice its size? The week may seem too long to the medical care provider, but if most medical practices of the same size take two weeks to process a claim, then the medical practice is actually doing much better than “normal.” In addition, much of the information that would help determine metrics for a medical practice's performance is protected under confidentiality agreements between medical providers and their vendors (e.g., insurance companies) such that the information should not be shared among medical practices.

Additionally, statistics are often compiled through the use of surveys, which are by their nature, opt-in systems, and may suffer from untimely compilation (e.g., yearly). As a result, statistics are often skewed because the statistics are based solely on the medical practices that volunteer their information and, compounding the problem, the information may not accurately reflect how a medical practice is in fact performing since there is little that can be done to authenticate the veracity of the provided information. An advantage of the medical practice benchmarking is that inter-practice statistics can be determined while maintaining the necessary anonymity of each particular practice.

As medical practices operate, trends develop regarding the processing of claims. For example, the average number of patients that pay at the time services are rendered. Statistics about the performance of the medical practice can be compiled and calculated based on just about any metric. But compiling statistics for a single practice is not typically helpful if those statistics are viewed in a vacuum. Those statistics should be compared against some standard to give insight to how well the practice is performing. One standard often used is generic baseline medical practice data that is established by collecting information from a number of medical practices through yearly surveys. The problem with comparing a medical practice to a generic baseline is that factors such as medical specialty, geographical location, and/or practice size are not reflected in the comparison, thus making the comparison less valuable as a business analysis tool.

Often, it is useful to compare the statistics of medical practices based on similarities between the practices. For example, it is beneficial to compare two medical care providers that see fifty patients a day (or, alternatively, a range of patients such as 50 patients ±10%). If the metric being compared is claim submission errors, it is advantageous to determine that the first medical practice has about the same number of claim errors as the second medical practice. Comparing statistics allows the first medical practice to establish a baseline of how a “normal” medical practice with its size, geographic location, and/or medical practice performs.

For example, it is less useful to compare the 50-patient medical care provider facility with a medical care provider that sees 300 patients a day. In the latter case, the 300-patient facility may have invested millions of dollars into a claim processing system, and thus may receive fewer claim errors despite the larger number of patients the 300-patient facility accommodates. Alternatively, a medical practice that has thirty percent of its claims rejected may feel that thirty percent is an unacceptably high claim rejection rate, but when compared to ten other practices that in aggregate average fifty percent claim rejections, thirty percent is quite above average.

Aside from size, it is also beneficial to compare a medical practice against another or others in the same specialty, again providing the medical practice some insight into what a “normal” medical care provider in that specialty (e.g., dermatology) accomplishes. Still another advantageous comparison is between medical care providers in the same geographical location, region, locale, part of the country, and/or country.

Advantageously, inter-practice statistics are also useful when negotiating contracts with medical practice vendors such as insurance companies. For example, if a particular medical practice is ranked first among all practices in a state by having the lowest charge entry lag time, that information may help the medical practice negotiate a better contract with an insurance company since charges are submitted and processed in a timely fashion. There are challenges with the combined information since it is, not readily shared between practices voluntarily because such sharing may violate confidentiality agreements between practices and/or their vendors. For example, some insurance companies may not be able to reveal to one medical practice how long it takes to process another medical practice's claims. Advantageously, the invention described herein provides aggregate, real-time (or near real-time) inter-practice statistics, while ensuring the anonymity of the practices that are providing the necessary information.

In accordance with Applicant's technology, medical practice information (e.g., insurance claim information) is received from a plurality of medical practices (e.g., 80% of the medical practices in Massachusetts). The medical practice information is then combined together so that inter-practice statistics can be determined based on the aggregated practice information. Part or all medical practice identifying information (e.g., the Winston Cardiologist Group address which associated with its patients) is removed from the aggregated practice information. The inter-practice statistics includes, for example, payment time for a particular procedure for a particular medical specialty in a geographic region (e.g., cardiologists in Massachusetts urban areas receive insurance payments for an angioplasty in 14.5 days) and/or any other type of statistic that allows a medical practice to analyze its insurance claims. The inter-practice statistics can be utilized to allow a medical practice to improve its insurance claim submissions based on successful submissions of other medical practices (e.g., emulating the submissions of successful medical practices).

For example, 100,000 of the medical practices in the New York City metropolitan area utilize the medical practice management system for submission of insurance claims to payor servers. There are ten million insurance claims with associated payment information from the medical practices which are combined together to form aggregated practice information. The medical practice identifying information from each of the medical practices is removed from the aggregated practice information (e.g., doctor information for the Fifth Street Doctor Group is removed from all of the insurance claims and payment information). An inter-practice statistic is determined from the aggregated practice information for the average payment time for coronary artery bypass surgery for all cardiologists in the New York City metro area. The average payment time is 21.5 days. Another inter-practice statistic is determined from the aggregated practice information for the average payment time for coronary artery bypass surgery for cardiologists in practices larger than forty doctors in the New York City metro area. The average payment time is 14.5 days. An additional inter-practice statistic is determined from the aggregate practice information for the average payment time for coronary artery bypass surgery for cardiologists in practices larger than one hundred doctors in the New York City metro area. The average payment time is 16.5 days. Dr. Smith can view these inter-practice statistics (in this example, 21.5, 14.5, and 16.5 days) and compare these statistics with the average payment time—20.3 days—for coronary artery bypass surgery at her medical practice which has sixty doctors.

Dr. Smith can utilize the ranking of her medical practice to improve the insurance claim submissions from her medical practice. Dr. Smith can make changes based on recommendations by the medical practice management system (e.g., require a check of the insurance pre-certification two days before the surgery) and/or Dr. Smith can allow the system to automatically make changes to improve the payment time. For example, the medical practice management system can automatically make changes to the submission of coronary artery bypass surgery insurance claim submissions to decrease the payment time for Dr. Smith's medical practice. For example, if successful medical practices always submit a surgery report signed by all of the doctors in the operating room, then the medical practice management system can require that all insurance claim submissions from Dr. Smith's medical practice include signatures from all of the doctors in the operating room during the procedure.

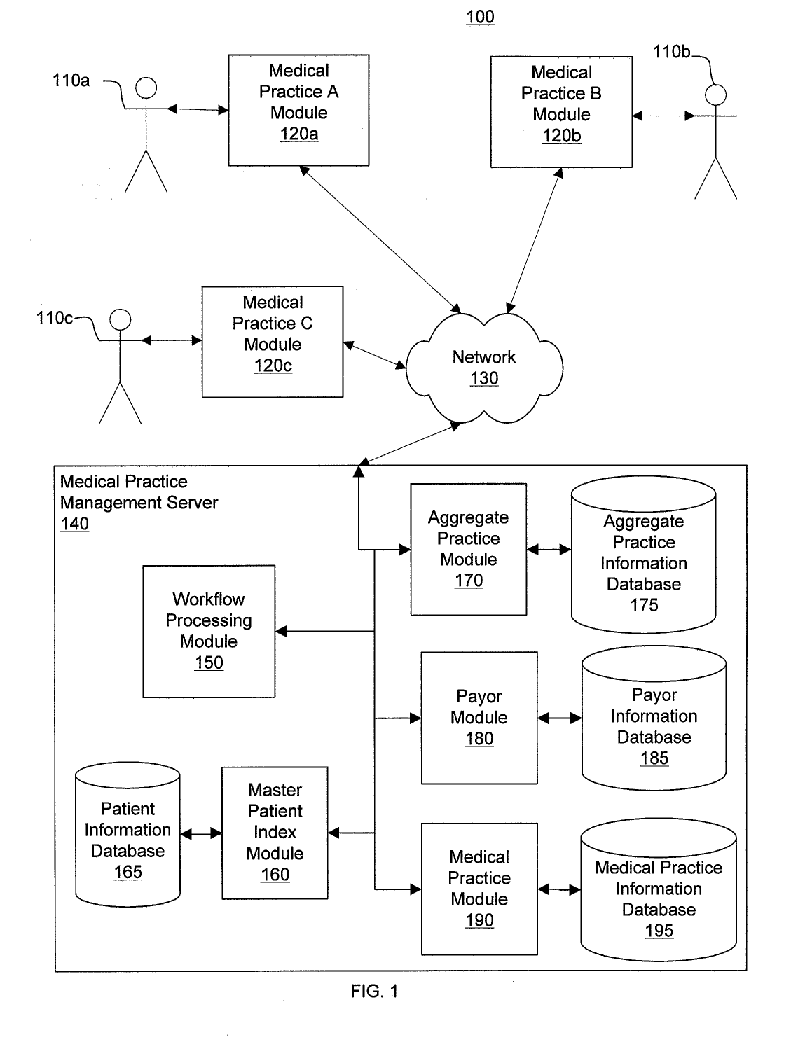

FIG. 1 depicts a block diagram 100 of an exemplary medical practice management system that includes medical practice modules 120a, 120b, and 120c (generally 120), a medical practice management server 140, and an aggregate practice module 170. The medical practice management server 140 includes a workflow processing module 150, a master patient index module 160, a patient information database 165, the aggregate practice module 170, an aggregate practice information database 175, a payor module 180, a payor information database 185, a medical practice module 190, and a medical practice information database 195.

Users 110a, 100b, and 110c (generally 110) utilize the medical practice modules 120a, 120b, and 120c, respectively, to communicate with the medical practice management server 140 utilizing a network 130. A user 110 utilizes the medical practice module 120 to submit insurance claims to the workflow processing module 150 though the network 130 (e.g., wide area network). The workflow processing module 150 communicates with the master patient index module 160 to retrieve, store, update, and/or check (e.g., confirm the accuracy of the information) patient information. The master patient index module 160 communicates with the patient information database 165 to retrieve, store, update, and/or check the patient information.

The workflow processing module 150 communicates with the payor module 180 to determine and/or update rules for the submission of the insurance claims (e.g., Insurance Company Alpha requires patient birthdate in a specified format—10/22/1970). The payor module 180 communicates with the payor information database 185 to retrieve, update, check, and/or store information about the payors (e.g., health insurance companies). The workflow processing module 150 communicates with the medical practice module 190 to retrieve, update, store, and/or check medical practice information. The medical practice module 190 communicates with the medical practice information database 195 to retrieve, update, check, and/or store information about the medical practices.

A user 110 utilizes the medical practice module 120 to communicate with the aggregate practice module 170 to retrieve inter-practice medical statistics. The aggregate practice module 170 determines inter-practice medical statistics by receiving practice information from the master patient index module 160, the payor module 180, the medical practice module 190, the medical practice modules 120 and/or any other external source of information (e.g., payor server). The aggregate practice module 170 aggregates the practice information to form aggregate practice information and determines the inter-practice medical statistics based on the aggregated practice information.

In some examples, the practice information includes insurance claim information and/or other information (e.g., medical practice information, medical encounter information, patient information). The aggregate practice module 170 can store, for example, the practice information, the aggregate information, and/or the inter-practice medical statistics in the aggregate practice information database 175.

In other examples, the inter-practice medical statistic is a mean, a variance, a deviation, a quintile, an average, a sample size, a mode, and/or any other statistic (e.g., descriptive statistic, inferential statistic). The inter-practice medical statistic can be, for example, associated with insurance claim information (e.g., insurance claim payment information). In some examples, the inter-practice medical statistics includes a lag time statistic, a payment statistic (e.g., how long did it take the payor to pay the insurance claim), a collection statistic (e.g., the number of insurance claims that are not collected within ninety days), a denial statistic (e.g., how many insurance claims are rejected on the first submission to a payor), an insurance claim statistic, and/or any other statistic associated with an insurance claim. The inter-practice medical statistics provide, for example, a statistical comparison between the insurance claim information of medical practice. For example, Dr. Allen can compare the insurance claim information of his medical practice to the insurance claim statistics of other national, regional, and/or local medical practices.

In some examples, the network 130 is a wide area network (WAN) connecting a plurality of medical practice offices to the medical practice management server 140 and/or a medical practice management network. The network 130 can be, for example, a public communication network (e.g., Internet) and/or a private communication network (e.g., Intranet).

In other examples, the medical practice management server 140 is a web server hosting a web application that the user 110 utilizes to submit and/or access information associated with the user's medical practice. The medical practice management server 140 can be, for example, an information interface that communicates information from a medical practice client application on a medical practice module 120 (e.g,. computing device) that the user 110 utilizes to submit and/or access information associated with the user's medical practice.

The patient and/or clinic workflow can be, for example, processed by the workflow processing module 150. Although FIG. 1 illustrates workflow functionality via the workflow processing module 150, other examples provide workflow functionality via a message passing interface (not shown). The message passing interface can be utilized, for example, to communicate between the user 110 and the medical practice management server 140.

In some examples, the medical practice is the office of the medical care provider (e.g., a doctor's office), a hospital, and/or any other facility for medical encounters. Although also referred to as an insurance company, the payor organization can include, for example, health maintenance organizations (HMOs). Payor organizations include, for example, Century Health and Benefits, HMO Blue, Harvard Pilgrim Health Care, MassHealth, Medicare, Neighborhood Health Plan, Tufts Associated Health Plan, and/or United Healthcare.

Although FIG. 1 illustrates three medical practice modules 120 communicating through the network 130 to the medical practice management server 140, a plurality of medical practice modules (e.g., one hundred, one thousand, ten thousand) can, for example, communicate with the medical practice management server 140. In some examples, the medical practice modules 120 communicate through a plurality of networks (e.g., local area networks connected to the Internet) to the medical practice management server 140.

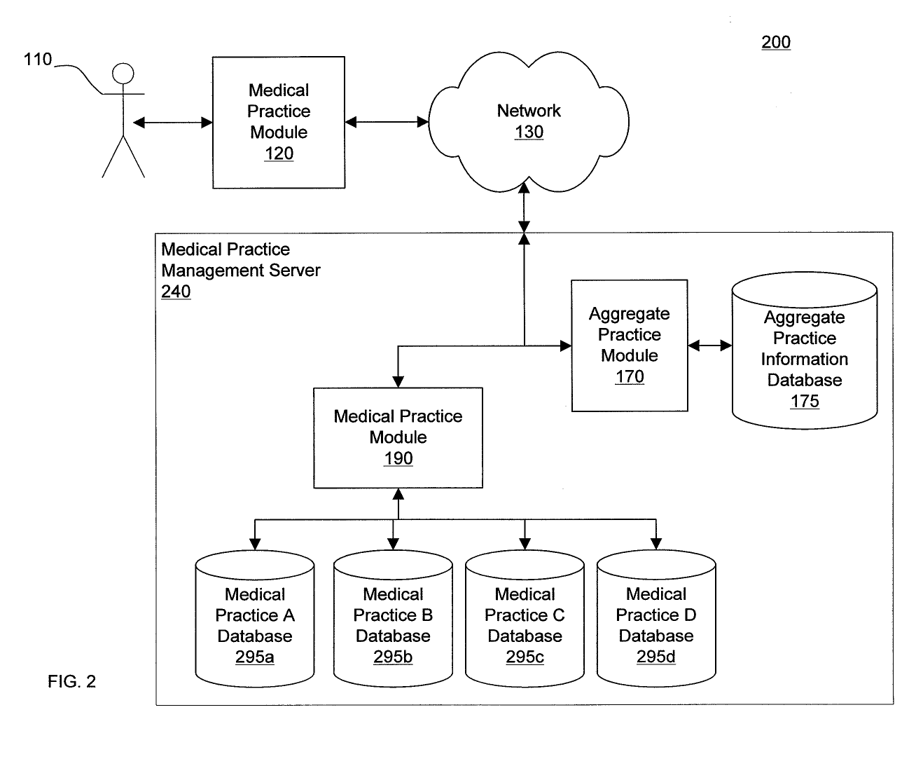

FIG. 2 depicts a block diagram of an exemplary medical practice management system 200 that includes a medical practice module 120 and a plurality of medical practice databases 295a, 295b, 295c, and 295d. The medical practice management system 200 includes a medical practice module 190, medical practice databases A 295a, B 295b, C 295dc, and D 295d (generally 295), an aggregate practice module 170, and an aggregate practice information database 175. A user 110 utilizes the medical practice module 120 to communicate with the medical practice management server 240 through a network 130.

The medical practice databases A 295a, B 295b, C 295dc, and D 295d store medical practices information from medical practices. In some examples, each medical practice database A 295a, B 295b, C 295dc, and D 295d stores medical practice information from medical practice A (not shown), medical practice B (not shown), medical practice C (not shown), and medical practice D (not shown), respectively. The advantage of storing the medical practice information in separate databases is to ensure that the medical practice information is not inter-changed between the medical practices. The storage of the medical practice information can be configured, for example, to comply with applicable government regulations and/or laws, agreements (e.g., the medical practice privacy policy, payor contract), and/or industry standards.

In other examples, each medical practice database A 295a, B 295b, C 295dc, and D 295d stores medical practice information from a particular medical practice group (e.g., medical specialty). For example, medical practice database A 295a stores all of the medical practice information for all of the medical practices in the Boston metropolitan area (in this example, Boston practice group).

In some examples, the plurality of medical practices is part or all of a medical practice group. The medical practice group can be, for example, a grouping of medical practices based on the number of patients, the number of doctors, the medical specialty, the location(s), and/or any other information associated with a medical practice group (e.g., percentage of specialty doctors). The medical practice group can be used, for example, to group medical practices together for statistical analysis. For example, Dr. Edwards is a plastic surgeon in Los Angeles and requests the medical statistic for the hold time of insurance claims for reconstructive surgery of the face (e.g., procedure code AB321) for every plastic surgeon in urban areas (e.g., more than 100,000 people). The grouping of every plastic surgeon in urban areas is a medical practice group that allows Dr. Edwards to receive informative medical statistic information that allows her to compare her practice to other plastic surgery practices in similarly situated locations (in this example, urban areas).

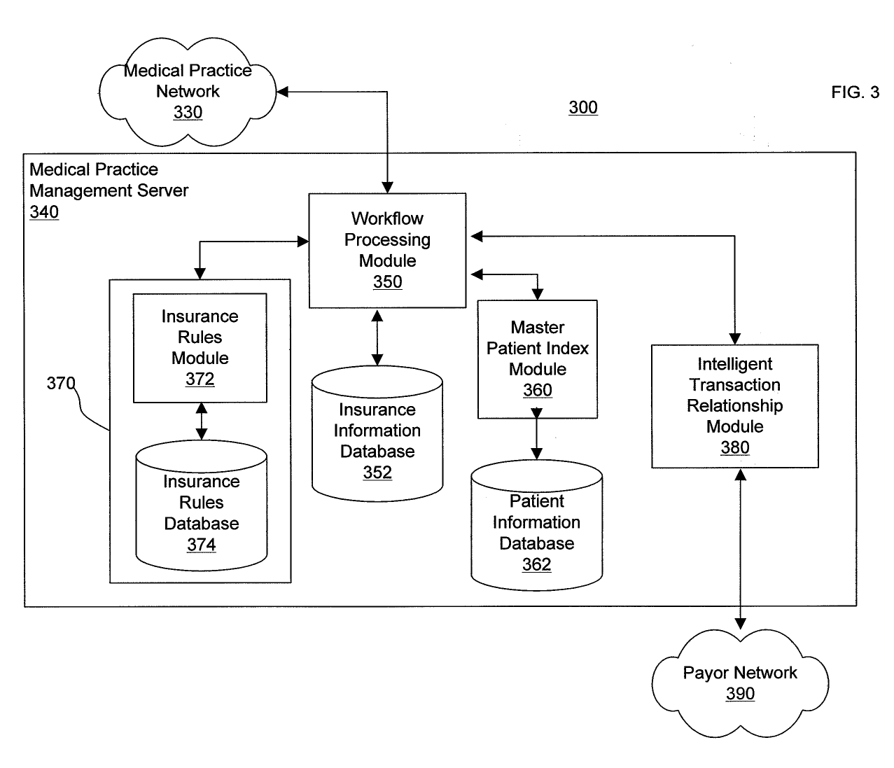

FIG. 3 depicts a block diagram of an exemplary medical practice management system 300 that includes a medical practice network 330, a medical practice management server 340, and a payor network 390. The medical practice management server 340 includes a workflow processing module 350, a rules module 370, and an intelligent transactions relationship (ITR) module 380. The rules module 370 includes an insurance rules module 372 and an insurance rules database 374.

The medical practice management server 340 includes a patient information database 362 and an insurance information database 352. The workflow processing module 350 stores part or all of the information associated with a patient in the patient information database 362. The patient information database 362 stores information associated with patients of the medical practice. The information can include, for example, the patient's address, phone number, zip code, height, weight, allergies, previous doctor(s), and/or other information associated with the patient.

In some examples, the workflow processing module 350, the rules module 370, and/or the ITR module 380 are software modules located within the medical practice management server 340. In other examples, the workflow processing module 350, the rules module 370, and/or the ITR module 380 are externally located from the medical practice management server 340 and communicate with the medical practice management server 340. In other examples, the rules module 370 includes a patient rules module (not shown) that processes rules associated with patients, and/or other types of rule modules that process rules associated with healthcare.

In some examples, the workflow processing module 350 is a software application that controls and manages the features and functions of the medical practice management server 340. The workflow processing module 350 and the medical practice module (not shown) communicate over the medical practice network 330. The medical practice module can transmit a medical care provider request containing information to the medical practice management server 340 using, for example, a common gateway interface (CGI) request. For example, when registering a new patient, a medical care provider operating the medical practice module enters the relevant patient information on a patient registration template that the workflow processing module 350 delivered to the medical practice client user interface (not shown).

In other examples, the workflow processing engine 350 validates the structure and composition of information entered by a medical care provider at the medical practice client to ensure that the information is correct (e.g., structure and/or composition). Examples of information entered by a medical care provider at the medical practice client include the patient's address, phone number, medical history, insurance information, diagnosis and procedure codes, and/or other information associated with a healthcare patient.

In some examples, the workflow processing engine 350 communicates with the rules module 370. The rules module 370 enables real-time application of “rules” stored in the rules database (not shown). A rule can be, for example, coded logic that evaluates data and then performs an action.

The rules module 370 can access and update, for example, information stored in the insurance rules database 374 using the insurance rules module 372. Although FIG. 3 illustrates the rules module 370 external to the workflow processing module 350, the rules module 370 can be, for example, a software layer internal to the workflow processing module 350. In some examples, the rules module 370 is implemented as an application program interface, a Component Object Model (COM) object, an Enterprise Java Bean, and/or any other type of database interface module.

The insurance rules database 374 and/or the interface to the insurance rules database 374 can be written, for example, in a structured query language. In some examples, the insurance rules module 372 uses a Lightweight Directory Access Protocol (LDAP) to access information in the insurance rules database 374. Additionally or alternatively, the insurance rules database 374 can be external to the medical practice management server 340 (e.g., distributed across three geographically dispersed data centers) or can be internally situated in the medical practice management server 340.

The insurance rules database 374 includes insurance company rules that define the appropriate format and content of clinical and claim information that the payor server (not shown) processes. In some examples, the rules are subdivided into various classes. For example, the rules are divided into rules that have universal applicability to all claims for a specified payor, rules that apply only to one or more specific insurance packages from among the variety of insurance packages that the payor offers to medical care providers, and/or rules that apply only to specific medical care providers who provide care under one or more specific insurance packages.

To ensure that the insurance rules database 374 contains current rules, the insurance rules database 374 can be, for example, frequently updated. In some examples, individual payors transmit rule updates/creations to the medical practice management server 340 via their payor server. Rule specialists can, for example, review the rules transmitted by the payor server and subsequently update the insurance rules database 374. In some examples, the rules specialist performs any and all updates to the insurance rules database 374. In other examples, the updating of the insurance rules database 374 can be automated upon receipt of a rule transmission from the payor server or the medical practice client.

In some examples, a medical care provider can submit information to the medical practice management server 340 for subsequent update of the insurance rules database 374 based on the medical care provider's experience with one or more payors. In other examples, the insurance rules database 374 is updated with the server's historical analysis of previously submitted claims, especially those that were denied, to identify the reasons for denial. The historical analysis of previously submitted claims can facilitate the development of new insurance rules for the insurance rules database 374.

In some examples, the medical practice management server 340 indexes the patient information stored in the patient information database 362 by the patient name. In other examples, the medical practice management server 340 indexes the patient information stored in the patient information database 362 with a patient identifier. The patient identifier can be, for example, a random number, a predetermined integer (such as a patient counter), the patient's zip code, the patient's phone number, and/or any other type of identifier associated with a patient. The workflow processing module 350 can access the patient information database 362 using, for example, a master patient index module 360.

In other examples, the workflow processing module 350 stores information associated with an insurance company in the insurance information database 352. The information associated with an insurance company includes the insurance company's address, the amount of insurance coverage for a particular patient, and/or other information associated with an insurance company. In some examples, the workflow processing module 350 can access the insurance information database 352 using an insurance information database module (not shown).

In some examples, as the workflow processing module 350 receives information from the medical practice client, the workflow processing module 350 determines on a real time basis whether all of the required information has been provided and/or whether the information is in the correct format. In the event that there is a deficiency and/or error in the information, the workflow processing module 350 alerts the medical care provider (e.g., receptionist), or user, for additional information and/or to correct the information. In other examples, the workflow processing module 350 corrects the defect and/or error.

For example, if the insurance rules module 372 contains a rule about member identification formatting for a particular payor, the insurance rules module 372 determines the rule in the insurance rules database 374 and communicates the information to the workflow processing module 350. The workflow processing module 350 communicates this information to the medical practice client when a medical care provider (e.g., receptionist) is registering a patient. If the medical care provider (e.g., receptionist) errs, the medical practice management server 340 alerts the medical care provider (e.g., with a warning message) to correct the error. This enables medical care providers to generate claims with no errors (i.e., referred to as clean claims) for the mutual benefit of the medical care provider and the payor. Additionally, the medical care providers can obtain the information associated with an alert while the patient is physically present (e.g., while the patient is still at the hospital, during their encounter, before checking out).

The workflow processing module 350 can be, for example, in communication with the ITR module 380. The ITR module 380 executes transactions sent to and/or received from the payor server via the payor network 390. Thus, the majority of provider/payor transactions can be accomplished electronically, with little or no human intervention. Examples of these transactions include, without limitation, claim submittals, claim receipt acknowledgements, claim status checks, patient eligibility determinations, authorization and referral requests and grants, and/or remittance advice. For example, a predetermined number of days before a scheduled patient visit, the ITR module 380 automatically checks patient eligibility with the applicable payor identified during the patient registration process. After a patient visit and the completion of the claim template, the claim is submitted to the payor server via the ITR module 380.

In some examples, upon receipt of an insurance claim, the payor transmits a confirmation back to the medical practice management server 340. Later, on a schedule determined by the medical care provider (e.g., weekly, monthly), the ITR module 380 checks the claim status and notifies the medical practice client accordingly. After the ITR module 380 analyzes the claim and generates remittance advice, the ITR module 380 parses the electronic payment and allocates the payment among the individual charge line items for the services provided. Once the medical care provider approves the allocations, the payments are posted to the provider's accounts.

In other examples, insurance rules database 374, insurance information database 352, and/or patient information database 362 are encrypted which advantageously complies with applicable laws and/or regulations. The information stored and/or associated with the medical practice management server 340 can be, for example, encrypted. The encryption of databases and/or information can be, for example, advanced encryption standard (AES), data encryption standard (DES), and/or any other type of encryption method and/or module. The encryption can be, for example, hardware based encryption and/or software based encryption.

In some examples, financial information is removed from the insurance rules database 374, insurance information database 352, patient information database 362, and/or any other information stored and/or associated with the medical practice management server 340. Part or all of the financial information can be, for example, removed and/or hidden (e.g., remove all but the last four digits of the social security numbers). The financial information can be, for example, removed from the primary database where the information is being stored (e.g., patient information database 362) and stored in a separate database. For example, the social security numbers are removed from all patient information stored in the patient information database 362 and placed in the secure patient information database (not shown). The information in the patient information database 362 and the secure patient information database can be associated with each, for example, by utilizing an assigned patient ID. The information in the secure patient information database can be secured, for example, utilizing a password, personal identification number, biometrics, and/or any other security mechanism. The financial information can include, for example, social security numbers, credit card numbers, bank account numbers, and/or any other information associated with finances.

Although FIG. 3 illustrates the modules insurance rules module 372, workflow processing module 350, master patient index module 360, and intelligent transaction relationship module 380 as separate modules, the modules 372, 350, 360, and 380 can be combined, for example, into one module or any number of modules. Similarly, the databases, insurance rules database 374, insurance information database 352, and patient information database 362 can be combined, for example, into one database and/or can be external or internal to the medical practice management server 340.

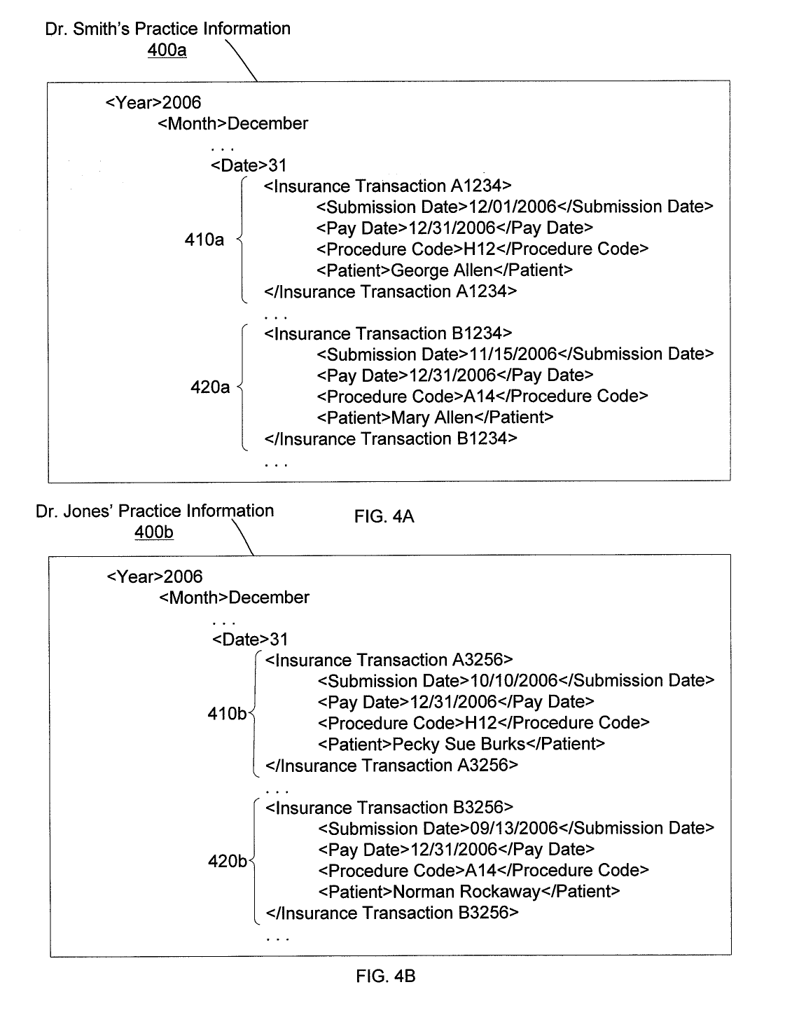

FIG. 4A is a diagram 400a depicting exemplary medical practice information 410a and 420a. The diagram 400a depicts medical practice information from Dr. Smith's medical practice. The medical practice information includes insurance transactions 410a and 420a. The insurance transactions 410a and 420a include a transaction id (in 410a, A1234), submission date, pay date, procedure code, and patient. In some examples, the insurance transaction information includes other information that a payor server utilizes to process insurance claims.

FIG. 4B is a diagram 400b depicting exemplary medical practice information 410b and 420b. The diagram 400b depicts medical practice information from Dr. Jones' medical practice. The medical practice information includes insurance transactions 410b and 420b. The insurance transactions 410b and 420b include a transaction id (in 410b, A3256), submission date, pay date, procedure code, and patient. In some examples, the insurance transaction information includes other information that a payor server utilizes to process insurance claims.

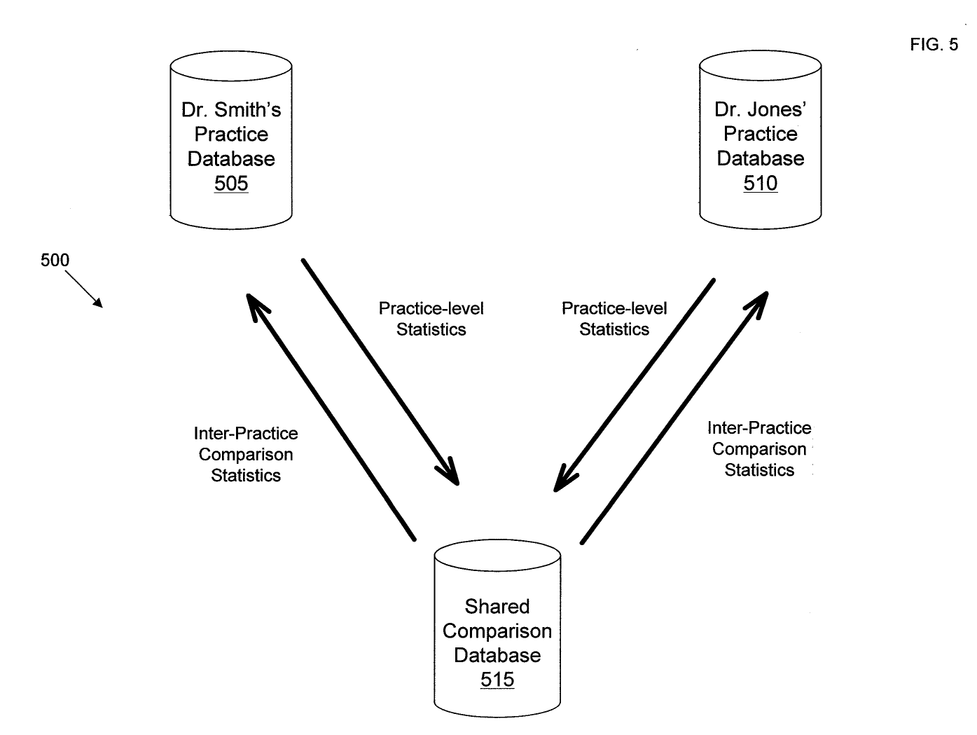

FIG. 5 depicts a block diagram 500 of exemplary medical practices databases 505 and 510 communicating with a shared database 515. The practice-level statistics for Dr. Smith's medical practice are communicated between Dr. Smith's practice database 505 (e.g., medical practice database A 295a of FIG. 2) and the shared comparison database 515 (e.g., aggregate practice information database 175 of FIG. 2). The practice-level statistics for Dr. Jones' medical practice are communicated between Dr. Jones' practice database 510 (e.g., medical practice database B 295bof FIG. 2) and the shared comparison database 515. The shared comparison database 515 determines inter-practice comparison statistics and communicates the inter-practice comparison statistics to Dr. Smith's practice database 505 and Dr. Jones' practice database 510.

In some examples, the inter-practice comparison statistics are stored on the medical practice database (in this example, Dr. Smith's practice database 505). The medical practice database can be, for example, stored at the medical practice and/or a central location with other medical practice databases (e.g., the medical practice management server 240 of FIG. 2).

In other examples, patient and/or medical practice information is removed from the medical practice information before the medical practice information is transmitted to the shared comparison database 515 and/or the aggregate practice module 170 of FIG. 1 (e.g., at the medical practice module 120, at the medical practice information database 195). In some examples, the patient and/or medical practice information is removed at the shared comparison database 515 and/or the aggregate practice module 170 before the information is aggregated. In other examples, the patient and/or medical practice information is removed from the aggregated information. In some examples, the patient and/or medical practice information is filtered out during the aggregation of the aggregated information. Thus, the identifying information is not part of the aggregated information. In other examples, the patient and/or medical practice information is encrypted to secure the information. The encryption can occur, for example, at the shared comparison database 515, the aggregate practice module 170, the medical practice information database 195, the medical practice module 120, and/or at any other module and/or database in which the information is processed and/or stored.

The removal, filtering, and/or encryption of the patient and/or medical practice information can be configured, for example, to comply with government regulations and/or laws regarding healthcare information (e.g., health insurance portability and accountability act (HIPAA)). The removal, filtering, and/or encryption of the patient and/or medical practice information can be configured, for example, to comply with privacy agreements (e.g., the medical practice privacy policy) and/or industry standards for patient privacy and/or confidentiality.

The patient and/or medical practice information that is removed, filtered, and/or encrypted includes, for example, confidential information (e.g., patient identifying information), sensitive information (e.g., which patient has a certain disease), private information (e.g., patient's social security number, information that associates an individual patient with a medical encounter (e.g., the patient's name with an insurance claim), and/or any other medical information that cannot be shared among medical practices. An advantage to removing, filtering, and/or encrypting the identifying information is that each medical practice can comply with the applicable restrictions while still obtaining benchmark information that can improve the insurance claim submissions for the medical practice.

In some examples, databases, database tables, and/or columns in a database are used to store information about a medical practice, such as, outstanding claims, accounts receivable information and/or other information. The storage of the medical practice data for medical practices can be based, for example, on a subscription to the medical practice management system 100 of FIG. 1 by the medical practice.

In other examples, each practice that the medical practice management system 200 stores information for (e.g., all the practices that subscribe to the system 200) may each have an individual database (e.g., medical practice databases A 295a, B 295b, C 295c, and D 295d). The individual databases, records, and/or information for the individual practices generally do not contain information about other practices. For example, Dr. Smith's practice database 505 does not contain information related to Dr. Jones' practice, even though the two may share one or more patients. Advantageously, at this level, the practices and/or insurance companies are in compliance with confidentiality agreements, guidelines, and/or government regulations and laws because effectively no information is shared inter-practice. As a result, Dr. Smith and Dr. Jones cannot determine how well their respective practices compare against the other's practice.

Advantageously, however, inter-practice statistics determined by the aggregate practice module 170 provide for a comparison of medical practices while maintaining compliance with legal obligations such as established confidentiality contracts. The shared comparison database 515 allows for the sharing of information, whereby practice information from Dr. Smith's practice and Dr. Jones' practice is pooled together and is provided to the practices in the form of inter-practice statistics. Practice-level statistics (e.g., charge entry lag, HOLD lag, MGRHOLD lag, and/or percentage of self-pay after ninety days) are pooled into an aggregate information database (e.g., 175).

In some examples, pooling the data together involves copying rows of data from the individual practice databases 505 and 510 into a shared comparison data database 515. In other examples, as data is written to the individual medical practice databases (e.g., 295a, 295b, 295c, 295d), a write operation is performed on the shared comparison data database 515 that represents the information written to the individual practice databases. For example, an update to Dr. Smith's Database 505 charge entry lag table and/or column also sends an update command to the shared comparison data database 315 charge entry lag table and/or column.

In some examples, a database view is created that aggregates database commands to reflect the shared data (e.g., via a SQL statement that issues SELECT commands to multiple databases, tables, and/or columns). Advantageously, Dr. Smith and Dr. Jones do not know they are being compared against each other. A level of anonymity is maintained such that Dr. Smith and Dr. Jones respectively can only ascertain how well their respective practices are performing compared to some standard (e.g., practices of a similar size, similar specialty, and/or in a similar geographic location). This prevents Dr. Smith and Dr. Jones from determining the confidential business information belonging to the other (e.g., Dr. Smith does not need to know, nor should he know, how long Dr. Jones' practice takes to process claims). Dr. Smith only needs to know his practice is performing better or worse than the average for a given period (e.g., seven days, for a given metric, for a given practice parameter (e.g., specialty)). Beneficially, the information is provided in real-time or near real-time (e.g., an update to Dr. Smith's charge entry lag table is reflected in the shared charge entry lag table). In other examples, the information is updated on a periodic basis (e.g., hourly, daily, weekly, monthly, quarterly).

In some examples, the necessary calculations are divided into work units and processed separately. In other examples, the medical practice management server 140 is part of a server farm, the individual work units may be processed by different servers in the server farm. Parallel processing of the work units allows more statistics to be calculated in the same time period. For example, one server calculating statistics for three medical practices and between the practices could take three times as long as three servers each calculating statistics for one medical practice.

The information (e.g. charge entry lag data) is collected in a distributed way for each practice on a periodic (e.g., daily). Each period, the collected information is added to the shared comparison data database 515. This shared comparison data database 515 is queried (e.g., by the medical practice management server) to compute inter-practice statistics (e.g., the number of practices in the comparison group, the median value for each metric within each comparison group, and/or the rank of each individual practice within the group. The inter-practice statistics are then copied back to the practice database during the same period (e.g., daily) so that the inter-practice statistics can be displayed to users of the medical practices modules 120 without querying the shared comparison data database 315 each time. Rather, the medical practice databases on the individual practices are queried and interacted with by the respective medical practices. For example, Dr. Smiths' medical practice interacts with Dr. Smith's practice database 505, which after receiving the inter-practice statistics from the shared comparison data database 515, can then be queried by a medical practice module (not shown) at Dr. Smith's medical practice, for example, via the medical practice management server 240. Advantageously, for medical practices that subscribe to the medical practice management system 100 of FIG. 1 as part of a subscription-based model, information can be collected as interactions are made between the medical practice module 120 and the medical practice management server 140 (e.g., tracking patient check-ins, payments at the time of service, interactions between the medical practice management server 140 and payor servers (e.g., when claims are submitted to the payors, information such as claim rejections, holds)).

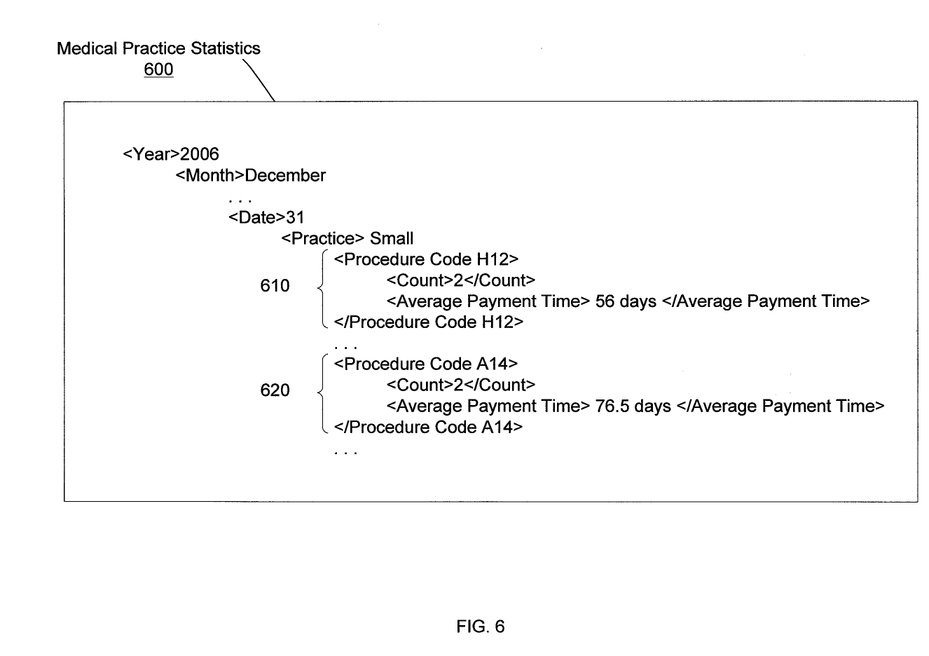

FIG. 6 is a diagram 600 depicting exemplary medical practice statistics 610 and 620. The statistics 610 and 620 are based on Dr. Smith's and Dr. Jones' practice information 400a and 400b, respectively. The statistics 610 for procedure code H12 are based on Dr. Smith's insurance transaction A1234 410a for procedure code H12 and Dr. Jones' insurance transaction A3256 410b for procedure code H12. The statistics 610 for procedure code H12 include a count of two and an average payment time of fifty six days. The statistics 620 for procedure code A14 are based on Dr. Smith's insurance transaction B1234 420a for procedure code A14 and Dr. Jones' insurance transaction B3256 420b for procedure code A14. The statistics 620 for procedure code A14 include a count of two and an average payment time of 76.5 days.

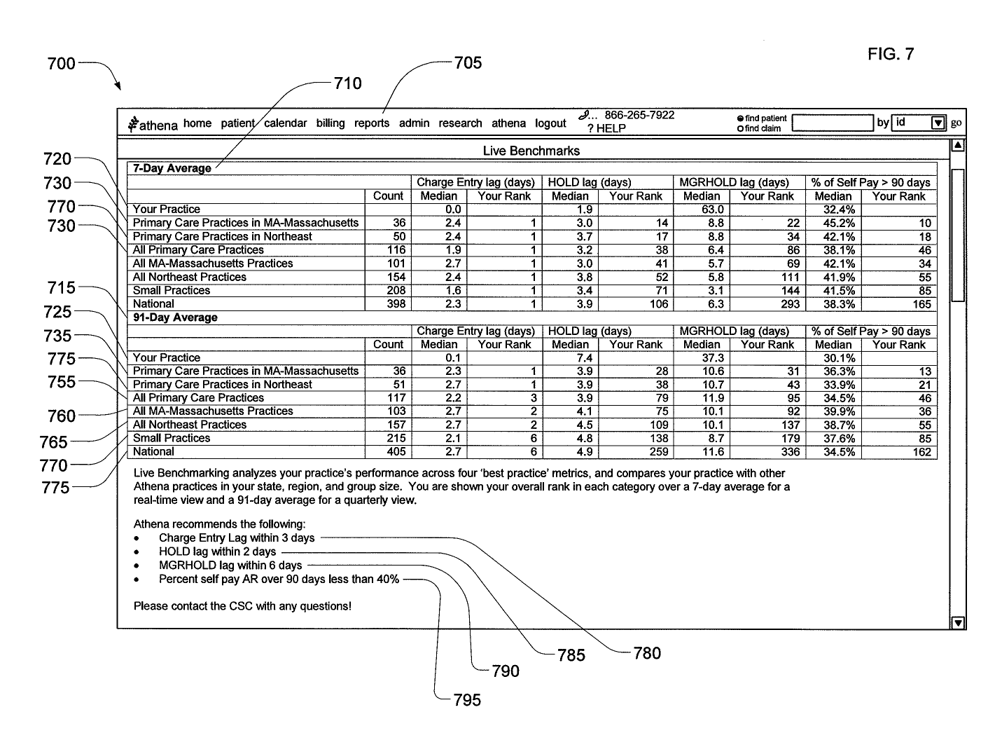

FIG. 7 depicts a screenshot 700 presented in a web browser 705 of exemplary inter-practice statistics. For example, Dr. Smith could view the inter-practice statistics as compared to the user's practice. In some examples, the statistics are calculated by the medical practice management server 140 of FIG. 1 and presented via a web browser on a medical practice module 120.

As depicted, practice and inter-practice statistics for one or more time periods can be displayed at one time, in this example, a seven day average 710 and a ninety-one day average 715. For each average, statistics 720 and 725 are provided “your practice” that indicate to the user the performance for the user's medical practice. Exemplary statistics are charge entry lag, hold lag, manager hold lag, and/or percentage of self-pay after ninety days. Other statistics, though not displayed, may also be provided and include, but are not limited to, days in accounts receivable (DAR, a measure of how quickly each dollar of the practice's outstanding Accounts Receivable is being paid to the practice), collection rate at time of service, denial rates and/or related metrics such as first pass paid rate or first pass resolved rate.

For example, if the medical practice usually submits generally error-free claims (“clean claims”) to the payor server (not shown), denial rates are typically low because the claims contain few, if any, errors. Advantageously, first pass paid and/or resolved rates are correspondingly high because claims are resolved or paid on the first iteration through the medical practice management system 100 (e.g., on the first interaction with the payor servers). One metric often used is a return rate for hold status (e.g., a measure of how often claims that exit Hold or Manager Hold return to that status). For example, a practice that quickly clears claims with a Hold and/or Manager Hold status may not correctly resolve the issues that caused the claims to be held. In those scenarios, the Hold and/or Manager Hold lags would be low, but the return rate would be high, illustrating to the practice that though claims were resolved quickly, the claims were not resolved correctly. Advantageously, knowing that claims are not submitted cleanly allows a practice to diagnose claim submission process and to receive reimbursement from payors in a more efficient manner.

In addition to the statistics of “your practice,” beneficially statistics are provided for practices with similar specialties for the state, region, and nationally and/or globally. In the example provided, the specialty is Primary Care. As depicted, inter-practice statistics are provided in both period sections 710 and 715 for Primary Care Practices in Massachusetts 730 and 735, Primary Care Practices in the Northeast 740 and 745, and All Primary Care Practices 750 and 755, respectively. Advantageously, the inter-practice statistics are useful to compare “your practice” to other practices that do not necessarily share the specialty of the medical practice.

For example, inter-practice statistics are provided to compare all Massachusetts practices 760, all Northeast practices 765, small practices 770 (e.g., practices that serve a limited number of patients, or alternatively, practices with a limited number of doctors), and all practices nationally 775. Though “small practices” are displayed, when the inter-practice statistics are requested by medium and large practices, those statistics are displayed to the respective practices.

In some examples practice size is based on the number of patients served. In other examples, practice size is based on the number of doctors at the medical care provider. For example, small practices typically have one to three doctors, medium groups are those with four to twenty five doctors, and large groups are those with twenty six or more doctors. In some examples, recommended statistics are provided. In this example, a charge entry lag of three days 780, a hold lag of two days 785, a manager hold (MGRHOLD) lag of six days 790, a percent self-pay AR over ninety days less than forty percent 795 are provided.

Ratings are provided to show how “your practice” is ranked for the provided metrics. For example, the practice depicted is first for all practices over the seven day average for charge entry lag. It is also first for Primary Care Practices in the Northeast for charge entry lag, but third for All Primary Care practices for the same category over a 91 day period. Such rankings are also advantageous when negotiating contracts with new payors and/or vendors to show, for example, reliability and accuracy of the medical practice in claim submission.

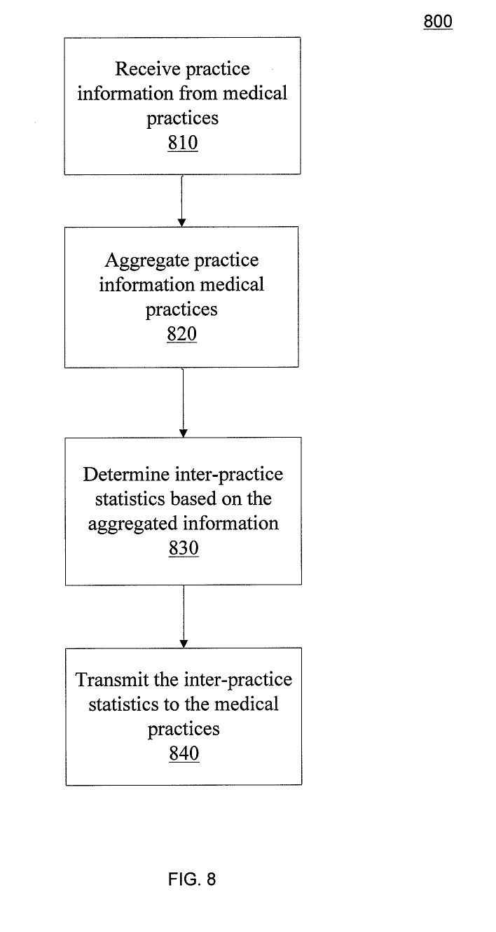

FIG. 8 depicts an exemplary flowchart 800 of inter-practice statistics through the medical practice management system 200 of FIG. 2. The aggregate practice module 170 receives (810) practice information from medical practice databases A 295a, B 295b, C 295c, and 295d D. The aggregate practice module 170 aggregates (820) the practice information from the medical practices. The aggregate practice module 170 determines (830) one or more inter-practice statistics based on the aggregated information. The aggregate practice module 170 transmits (840) the one or more inter-practice statistics to the respective medical practice modules (not shown) for each medical practice.

For example, the medical practice information for medical groups are stored in the medical practice databases: Main Street Heart Group in medical practice database A 295a, Georgetown Heart Associates in medical practice database B 295b, Young Heart Doctors in medical practice database C 295c, and West End Heart Associates in medical practice database D 295d. In some examples, the inter-practice statistics are transmitted (840) from the aggregate practice module 170 to the individual medical practice databases 295 for each respective medical practice. Main Street Heart Group can compare its individual statistics stored in its medical practice database A 295awith the inter-practice statistics. This comparison can be, for example, transmitted (840) to the medical practice module from which the user can access the statistics (e.g., screenshot 700 of FIG. 7).

In some examples, the aggregate practice module 170 transmits (840) the one or more inter-practice statistics to the medical practice modules (not shown) for utilization by the user at each medical practice (not shown). In other examples, the aggregate practice module 170 requests the medical practice information from the medical practice databases 295. In some examples, the medical practice databases 295 periodical (e.g., hourly, daily) submit updates to the aggregate practice module 170.

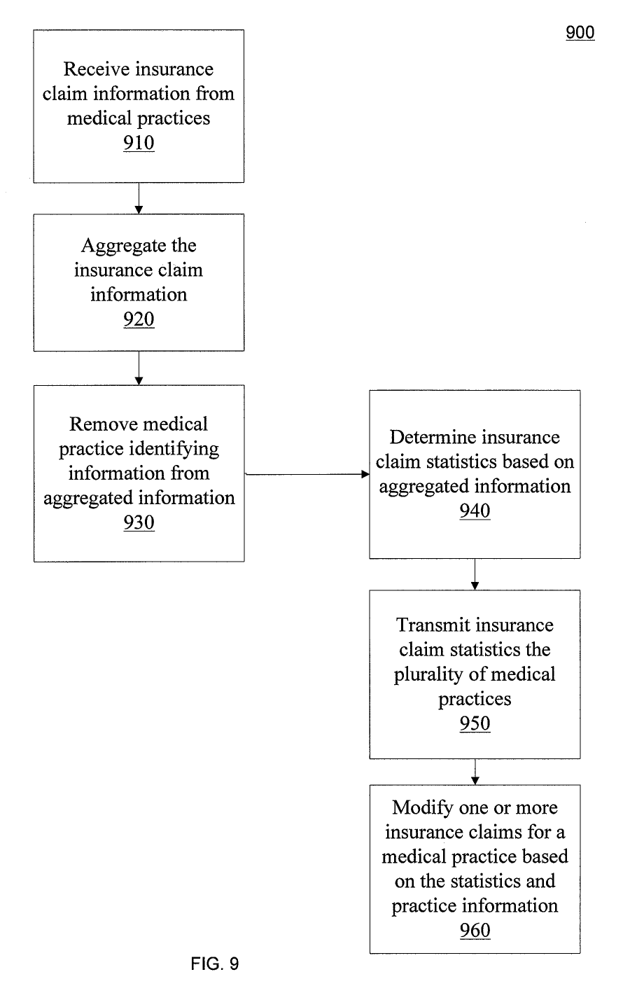

FIG. 9 depicts an exemplary flowchart 900 of insurance claim statistics as illustrated by the medical practice management system 100 of FIG. 1. The aggregate practice module 170 receives (910) insurance claim information from a plurality of medical practices. The insurance claim information can be received (910), for example, from the medical practice information database 195, the patient information database 165, the payor information database 185, and/or the medical practice modules 120.

The aggregate practice module 170 aggregates (920) the insurance claim information to form aggregated information and removes (930) identifying information from the aggregate information which would identify an individual medical practice. The aggregate practice module 170 determines (940) insurance claim statistics based on the aggregated information and transmits (950) the insurance claim statistics to the medical practice information database (195), the aggregate practice information database 175, the payor information database 185, and/or the medical practice modules 120.

The workflow processing module 150 modifies (960) one or more insurance claims for a medical practice based on the insurance claim statistic and/or the medical practice information. The modification (960) of the insurance claims can be automatic based on rules and/or preferences stored in the payor information database 185 and/or the medical practice information database 195. In other examples, the modification (960) of the insurance claims is manual process based on recommendations by the workflow processing module 150. The recommendations can be based, for examples, on how medical practices with improved practice statistics (e.g., ten day payment time versus thirty day payment time).

In some examples, the identifying information includes doctor information (e.g., Dr. Smith's name and degrees), practice location information (e.g., 123 Main Street, West End Town, N.Y.), practice information (e.g., ten radiologists and twelve x-ray machines), practice group information (e.g., Westside Radiologists is in the New York City Radiologist Group), and/or any other information associated with a medical practice.

In other examples, the inter-practice medical statistics are utilized by the user and/or the workflow processing module 150 to improve the insurance claim accuracy (e.g., more insurance claims are allowed by the payors during the first submission), insurance claim rejection rate (e.g., reduce the number of insurance claims that are rejected by the payors), lag time (e.g., decrease the time between the medical encounter and the insurance claim submission), payment time (e.g., decrease the time between insurance claim submission and payment), insurance claim submission (e.g., add additional information to insurance claims to increase the acceptance rate), and/or any other changes to improve the ranking of a medical practice. The improved insurance claim accuracy provides, for example, the benefit of improving the ranking of the medical practice. For example, a medical practice that improves the insurance claim accuracy improves from fifth in the regional rankings for claims allowed on first submission to third in the regional rankings for claims allowed on first submission.

For example, the inter-practice medical statistics indicates that ABC Pediatric Associates has an above average payment rate for office exams but a below average payment rate for blood tests. The medical practice management server 140 analyzes the insurance claim submissions of the successful practices (in this example, the above average payment rates for blood tests) with the ABC Pediatric Associate's insurance claims to determine how to decrease the payment rate for the medical practice. Based on this analysis, the medical practice management server 140 recommends changes (e.g., add the date of the last blood test to the insurance claim submission) to the insurance claim submissions to the office manager at ABC Pediatric Associates. The office manager accepts the recommendations to the insurance claim submissions and the medical practice management server 140 submits the insurance claim submission rule (in this example, add the date of the last blood test to all insurance claim submissions) to the medical practice module 190 for storage in the medical practice information database 195.

Examples of the medical practice information include, but are not limited to, the number of successful and/or unsuccessful claim submissions per day/week/month, the number of patients served per day/week/month, accounts receivable information, accounts payable information, information associated with vendor performance (e.g., how long a vendor such as a blood laboratory takes to complete a task), claim resolution lag, and/or any other information associated with a medical encounter.

In some examples, the information is received over a network. The information is then aggregated into a common data collection (e.g., database). During the aggregation process, the data is de-identified (i.e., identifying information is removed). For example, it is discernible that data from the first medical practice came from a medical practice of the size of the first medical practice, from a medical practice in the state of the first medical practice, and/or from a medical practice in the same specialty of the first medical practice, but it is not discernible that the data about the first medical practice is data from that particular medical practice.

In some examples the determination of the statistics is accomplished using a business logic rule. The business logic rule can be based, for example, on a set of rules that are evaluated based on compliance with confidentiality agreements and/or privacy regulations. In some examples, these business logic rules are part of the insurance rules module (not shown) and the rules are stored in the insurance rules database (not shown).

In other examples, a separate inter-practice statistic rules database (not shown) is provided that stores the rules. In examples where the insurance rules module (not shown) does not process the inter-practice statistic business logic rules, a separate business rules module (not shown) processes the inter-practice business logic rules. The software that determines the inter-practice statistics and the inter-practice rules module (in examples that utilize the inter-practice rules module) can execute, for example, on the medical practice management server 240 to determine the transmission of the inter-practice statistics.

Business rules evaluated by the medical practice management server 240 can limit, for example, the information provided based on the granularity of the information received. For example, if a sample size is too small (e.g., only two medical practices exist in a particular locale) then calculating and/or providing statistics to one practice would effectively reveal the statistics about the other practice. Because revealing such information would violate confidentiality agreements between the system provider and a medical practice, between the medical practice and the payors, and/or privacy regulations and/or guidelines, the medical practice management system 240 then does not determine and/or does not provide statistics derived from that level of granularity to a medical practice.

For example, if there are only two medical practices of a given specialty in the given town, then the business logic rule determines that the granularity is too small and the statistics comparing the two are not provided to either medical practice. If a request is made by a medical practice to compare the practice against similar practices in the entire state the state having thirty five such practices, then the medical practice management server 240 evaluating the business rule determines that the sample size is large enough and the statistics are provided to the requesting medical practice. Lastly, the inter-practice statistics are provided to the medical practices via the medical practice module (e.g., via a web browser).

In some examples, the medical practice module (e.g., 120) can be any computing device, personal computer, Windows-based terminal, network computer, wireless device, information appliance, RISC Power PC, X-device, workstation, mini computer, main frame computer, personal digital assistant, and/or other computing device that has a windows-based desktop. In other examples, the medical practice module (e.g., 120) can connect to a network and has sufficient persistent storage for executing a small, display presentation program (e.g., Java applet, CGI enable web page). Windows-oriented platforms supported by the medical practice module (e.g., 120) can include, for example and without limitation, Windows 3.X, Windows 95, Windows 98, Windows NT 3.51, Windows NT 4.0, Windows 2000, Windows XP, Windows Vista, Windows CE, Windows Mobile, Mac/OS, OS X, Java, Unix, and/or Linux. The medical practice module can include, for example, a visual display device (e.g., a computer monitor), a data entry device (e.g., a keyboard), persistent or volatile storage (e.g., computer memory) for storing downloaded application programs, a processor, and/or a pointing device such as a mouse or digitized pen.

In other examples, the medical practice module includes a medical practice client user interface. The medical practice client interface can be, for example, text driven (e.g., DOS) and/or graphically driven (e.g., Windows). In some examples, the medical practice client user interface is a web browser, such as Internet Explorer™ developed by Microsoft Corporation (Redmond, Wash.), to connect to the medical practice management server. In other examples, the web browser uses the existing Secure Socket Layer (SSL) support, developed by Netscape Corporation, (Mountain View, Calif.) to establish the medical practice network as a secure network.

In some examples, the medical practice management server and/or the payor server can be any personal computer. In another example, the medical practice management server hosts one or more applications that the medical practice module can access (e.g., employee time entry, medical database). The medical practice management server can be, for example, part and/or associated with a server farm (e.g., a logical group of one or more servers that are administered as a single entity).

The above-described systems and methods can be implemented in digital electronic circuitry, in computer hardware, firmware, and/or software. The implementation can be as a computer program product (i.e., a computer program tangibly embodied in an information carrier). The implementation can, for example, be in a machine-readable storage device and/or in a propagated signal, for execution by, or to control the operation of, data processing apparatus. The implementation can, for example, be a programmable processor, a computer, and/or multiple computers.

A computer program can be written in any form of programming language, including compiled and/or interpreted languages, and the computer program can be deployed in any form, including as a stand-alone program or as a subroutine, element, and/or other unit suitable for use in a computing environment. A computer program can be deployed to be executed on one computer or on multiple computers at one site.

Method steps can be performed by one or more programmable processors executing a computer program to perform functions of the invention by operating on input data and generating output. Method steps can also be performed by and an apparatus can be implemented as special purpose logic circuitry. The circuitry can, for example, be a FPGA (field programmable gate array) and/or an ASIC (application-specific integrated circuit). Modules, subroutines, and software agents can refer to portions of the computer program, the processor, the special circuitry, software, and/or hardware that implements that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer can include, can be operatively coupled to receive data from and/or transfer data to one or more mass storage devices for storing data (e.g., magnetic, magneto-optical disks, or optical disks).

Data transmission and instructions can also occur over a communications network. Information carriers suitable for embodying computer program instructions and data include all forms of non-volatile memory, including by way of example semiconductor memory devices. The information carriers can, for example, be EPROM, EEPROM, flash memory devices, magnetic disks, internal hard disks, removable disks, magneto-optical disks, CD-ROM, and/or DVD-ROM disks. The processor and the memory can be supplemented by, and/or incorporated in special purpose logic circuitry.

The components of the system can be interconnected by any form or medium of digital data communication (e.g., a communication network). Examples of communication networks include a LAN, WAN, the Internet, wired networks, and/or wireless networks.

The networks can be, for example, a wireless network and/or a wired network. The networks can be, for example, a packet-based network and/or a circuit-based network. Packet-based networks can include, for example, the Internet, a carrier internet protocol (IP) network (e.g., LAN, WAN, campus area network (CAN), MAN, home area network (HAN)), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, bluetooth, code-division multiple access (CDMA) network, time division multiple access (TDMA) network, global system for mobile communications (GSM) network), and/or other circuit-based networks.

The computing device can include, for example, a computer, a computer with a browser device, a telephone, an IP phone, a mobile computing device (e.g., cellular phone, personal digital assistant (PDA) device, laptop computer, electronic mail device), and/or other communication devices. The browser device includes, for example, a computer (e.g., desktop computer, laptop computer) with a world wide web browser (e.g., Microsoft® Internet Explorer® available from Microsoft Corporation, Mozilla® Firefox available from Mozilla Corporation). The mobile computing device includes, for example, a personal digital assistant (PDA).

Doctor and physician are open ended and include any type of healthcare professional referred to as a doctor and/or a physician. Comprise, include, and/or plural forms of each are open ended and include the listed parts and can include additional parts that are not listed. And/or is open ended and includes one or more of the listed parts and combinations of the listed parts.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

What is claimed is:

1. A computerized method for medical practice benchmarking, the method comprising:
receiving a plurality of practice information, which comprises insurance claim information and other information, associated with a plurality of medical practices;
aggregating the practice information to form aggregated practice information; and
determining one or more inter-practice medical statistics using the aggregated practice information, the statistics being associated with the insurance claim information and the statistics comprising at least one of a mean, a median, variance, deviation, quintile, average, sample size, or mode.

2. The method of claim 1 further comprising removing practice identifiable information from the aggregated practice information.

3. The method of claim 2, wherein the identifiable information comprises doctor information, practice location information, practice information, practice group information, or any combination thereof.

4. The method of claim 1, wherein the plurality of medical practices comprise a medical practice group.

5. The method of claim 4, wherein the medical practice group being grouped based on number of patients, number of doctors, medical specialty, location, or any combination thereof.

6. The method of claim 1, wherein the one or more inter-practice medical statistics comprises a lag time statistic, a payment statistic, a collection statistic, a denial statistic, an insurance claim statistic, or any combination thereof.

7. The method of claim 1, wherein the one or more inter-practice medical statistics comprises a statistical comparison between the aggregated practice information and the practice information associated with a first medical practice.

8. The method of claim 1, wherein the one or more inter-practice medical statistics being utilized to improve at least one of insurance claim accuracy, insurance claim rejection rate, lag time, payment time, or an insurance claim submission.

9. The method of claim 1 further comprising modifying one or more insurance claims of a first medical practice based on the one or more inter-practice medical statistics and the practice information associated with a first medical practice.

10. The method of claim 9, wherein the modification of the one or more insurance claim is utilized to improve a ranking of the first medical practice.

11. The method of claim 1 further comprising storing the aggregated practice information in an aggregated practice database.

12. The method of claim 1 further comprising transmitting the one or more inter-practice medical statistics to the plurality of medical practices.

13. The method of claim 1, wherein the one or more inter-practice medical statistics is determined in real-time.

14. The method of claim 1, wherein the one or more inter-practice medical statistics is determined on a periodic basis.

15. The method of claim 14, wherein the periodic basis is minutely, hourly, daily, weekly, monthly, quarterly, yearly, or any combination thereof.

16. A computer program product, tangibly embodied in an information carrier, the computer program product including instructions being operable to cause a data processing apparatus to:
receive a plurality of practice information, which comprises insurance claim information and other information, associated with a plurality of medical practices;
aggregate the practice information to form aggregated practice information; and
determine one or more inter-practice medical statistics using the aggregated practice information, the statistics being associated with the insurance claim information and the statistics comprising at least one of a mean, a median, variance, deviation, quintile, average, sample size, or mode.

17. A system for medical practice benchmarking, the system comprising
a medical practice module configured to receive a plurality of practice information, which comprises insurance claim information and other information, associated with a plurality of medical practices; and
an aggregate practice module configured to aggregate the practice information to form aggregated practice information and determine one or more inter-practice medical statistics using the aggregated practice information, the statistics being associated with the insurance claim information and the statistics comprising at least one of a mean, a median, variance, deviation, quintile, average, sample size, or mode.

18. The system of claim 17 further comprising a workflow processing module configured to modify one or more insurance claims of a first medical practice based on the one or more inter-practice medical statistics and the practice information associated with the first medical practice.

19. The system of claim 17 further comprising an aggregate practice information database configured to store the aggregated practice information.

20. The system of claim 17, wherein the aggregate practice module is further configured to remove practice identifiable information from the aggregated practice information.

21. The system of claim 17, wherein the aggregate practice module is further configured to transmit the one or more inter-practice medical statistics to the plurality of medical practices.

22. A system for medical practice benchmarking, the system comprising:
means for receiving a plurality of practice information, which comprises insurance claim information and other information, associated with a plurality of medical practices; and
means for aggregating the practice information to form aggregated practice information and determining one or more inter-practice medical statistics using the aggregated practice information, the statistics being associated with the insurance claim information and the statistics comprising at least one of a mean, a median, variance, deviation, quintile, average, sample size, or mode.
